(19) United States
(12) Patent Application Publication
(10) Pub. No.: US 2025/0350703 A1
(43) Pub. Date: Nov. 13, 2025

(54) PERSONALIZED DIGITAL MEETING AGENT

(71) Applicant: Microsoft Technology Licensing, LLC, Redmond, WA (US)

(72) Inventors: Kori Marie INKPEN, Redmond, WA (US); Edward B. CUTRELL, Seattle, WA (US); Sasa JUNUZOVIC, Kirkland, WA (US); John C. TANG, Palo Alto, CA (US); Patrick J. SWEENEY, Woodinville, WA (US); Richard L. HUGHES, Monroe, WA (US); Ashley FENIELLO, Deer Park, WA (US); Qianqian QI, Bellevue, WA (US); Asta J. ROSEWAY, Friday Harbor, WA (US); Joanne Sau Ling LEONG, Cambridge, MA (US)

(73) Assignee: Microsoft Technology Licensing, LLC, Redmond, WA (US)

(21) Appl. No.: 18/660,011

(22) Filed: May 9, 2024

(51) Int. Cl. H04N 7/15

(52) U.S. Cl. CPC H04N 7/15

(57) ABSTRACT

A digital agent is pre-trained to be a digital proxy for a user. Taking on the persona (e.g., personality, mannerisms, preferences, knowledge, and in some cases, a realistic visual appearance and voice of the human), the digital agent can effectively act on behalf of the human. During a virtual meeting, the pre-trained digital agent can listen to what the team has to say, ask clarifying questions, answer questions on the human's behalf, and raise points the human would want the team to consider. Since the digital agent visually resembles, sounds like, and acts like the human, the digital agent appears much like other remote participants, thereby improving the meeting experience of the other attendees and facilitating meeting productivity in the absence of a human team member.

### BACKGROUND

Work is increasingly characterized by highly diverse and global teams, with team members spread across different physical localities and time zones. Accordingly, business meetings are increasingly conducted virtually via video and/or audio conferencing. With such widespread use of virtual communications, scheduling conflicts are more likely to arise, for example, due to more flexible hybrid work schedules, global time zone differences, and the usual challenges of team members being out of the office for appointments, vacations, etc. As a result, people are often unable to join all of the meetings they are requested to or interested in attending.

It is with respect to these and other general considerations that embodiments have been described. Also, although relatively specific problems have been discussed, it should be understood that the embodiments should not be limited to solving the specific problems identified in the background.

### SUMMARY

To address the above challenges with meeting conflicts, aspects of the present application relate to a personal digital agent (or “Ditto”) that is pre-trained to be a digital proxy for a user (e.g., a human person). Taking on the persona (e.g., personality, mannerisms, preferences, knowledge, and in some cases, a realistic visual appearance and voice of the human), the personal digital agent is able to effectively interact on behalf of the human. For example, the digital agent can engage in conversations with meeting colleagues, having a similar voice, facial expressions, and body gestures as the non-attending human. Further, the pre-trained digital agent can listen to what the team has to say, ask clarifying questions, answer questions on the human's behalf, and raise points the human would want the team to consider. Since the digital agent visually resembles, sounds like, and acts like the human, the digital agent appears much like other remote participants, thereby improving the meeting experience of the other attendees and facilitating meeting productivity in the absence of a human team member.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which personal digital agents may be implemented, according to aspects of the present disclosure.

FIG. 2 illustrates an example virtual meeting interface in which personal digital agents may be implemented, according to aspects of the present disclosure.

FIGS. 3A-3C illustrate an overview of an example conceptual architecture for implementing personal digital agents, according to aspects described herein.

FIGS. 4A-4B illustrate an overview of an example conceptual architecture of a state machine for implementing personal digital agents, according to aspects described herein.

FIGS. 5A-5C illustrate an overview of an example method 500 for implementing personal digital agents, according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Aspects of the present application relate to a digital agent (or “Ditto”) that is pre-trained to be a digital proxy for a user (e.g., a human person). In some aspects, the digital agent may be dispatched to a meeting on behalf of the user. As used herein, a “meeting” may include any interaction between the digital agent and one or more human users and/or one or more other digital agents, whether formal or informal, scheduled or ad hoc, dyadic or non-dyadic. Meetings may be conducted via video- and/or audio-conferencing platforms, via phone, via text, or any combination thereof. By taking on the persona (e.g., personality, mannerisms, preferences, knowledge, and in some cases, a realistic visual appearance and voice) of the human, the digital agent is able to effectively interact on behalf of the human. For example, the pre-trained digital agent can listen to what the team has to say, ask clarifying questions, answer questions on the human's behalf, raise points the human would want the team to consider. More specifically, the digital agent can be trained to detect engagement by other attendees (e.g., via gaze detection), reasonably respond to questions or provide input either with or without human interaction, determine conversation mood and flow based on ambient and/or non-speech data (e.g., laughing, clapping, smiling, typing, etc.), among other skills. Further, an agent dashboard gives the human real-time visibility into the meeting, for example, enabling the human to intercede and respond for the digital agent, provide direct input or answer questions posed by the digital agent or other attendees, preview actions to be taken by the digital agent (including options to approve or disapprove), and join the meeting and replace the agent at any time. Since the digital agent visually resembles, sounds like, and acts like the human, the digital agent appears much like other remote participants, thereby improving the meeting experience of the other attendees and facilitating meeting productivity in the absence of the team member.

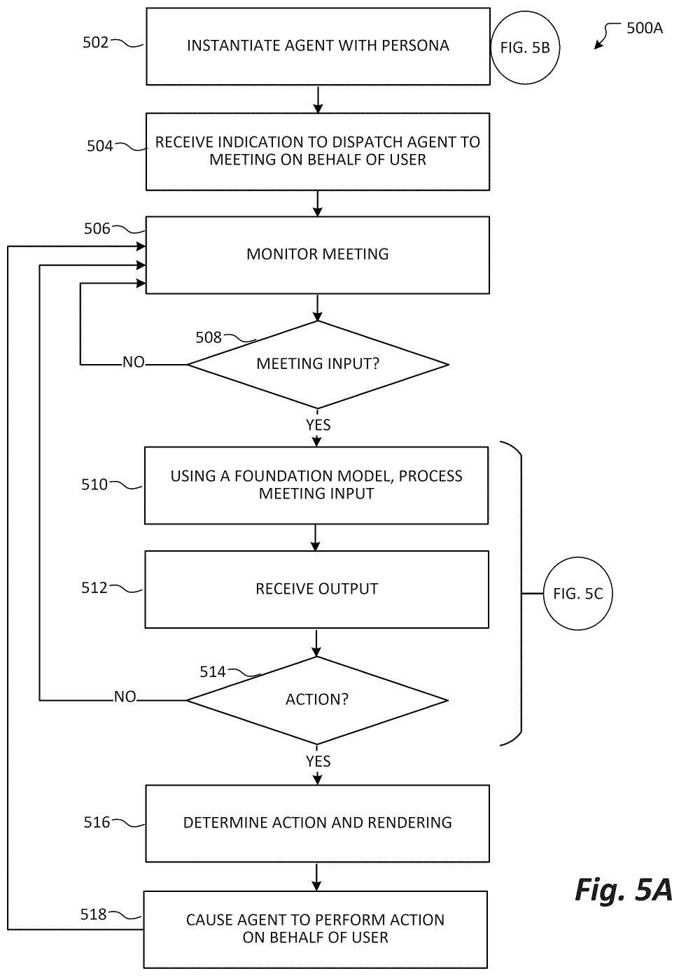

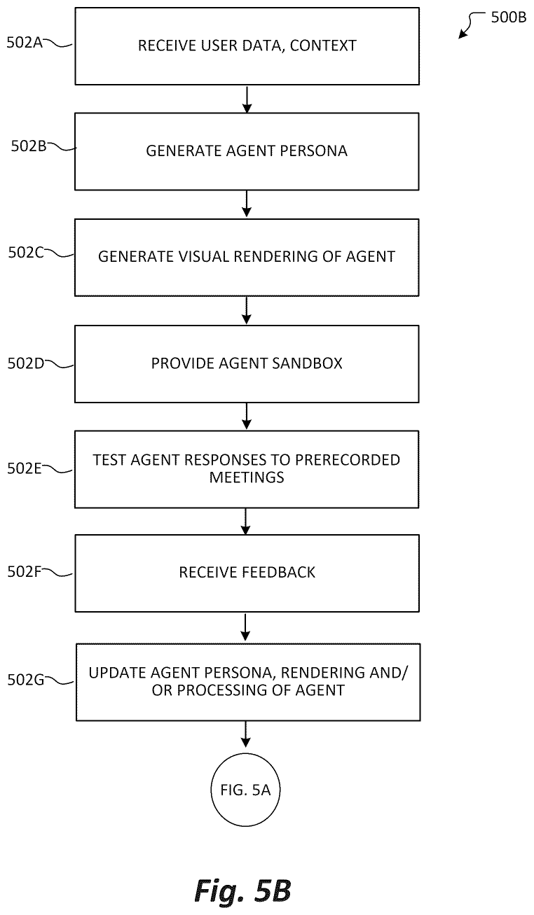

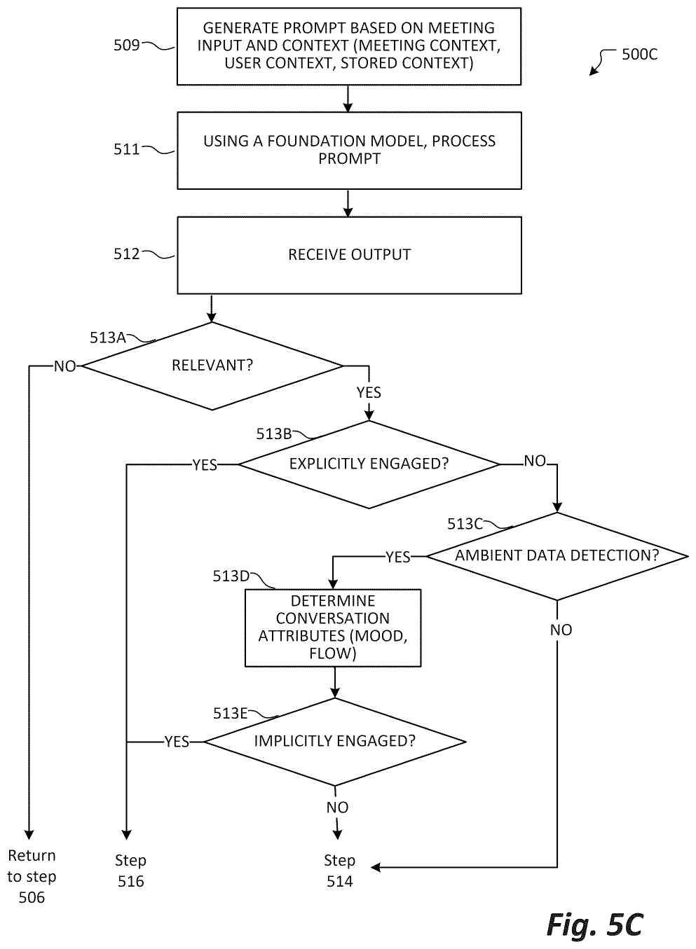

In examples, a generative model (also generally referred to as a foundation model) may be used according to aspects described herein and may generate any of a variety of output types (and may thus be a multimodal generative model, in some examples). For example, the generative model may include a generative transformer model and/or a large language model (LLM), a generative image model, or the like. Example models include, but are not limited to, Megatron-Turing Natural Language Generation model (MT-NLG), Generative Pre-trained Transformer 3 (GPT-3), Generative Pre-trained Transformer 3.5 turbo (GPT-3.5-turbo), Generative Pre-trained Transformer 4 (GPT-4), BigScience BLOOM (Large Open-science Open-access Multilingual Language Model), DALL-E, DALL-E 2, Stable Diffusion, Text-Curie-001, or Jukebox. Additional examples of such aspects are discussed below with respect to the generative ML model illustrated in FIGS. 5A-5B. Examples of existing embedding models include but are not limited to sentence-BERT (e.g., s-BERT all-MiniLM-L6-v2 or msmarco-distilbert-base-dot-prod-v3), CPU-optimized and quantized modes (e.g., ggml-all-MilniLM-L6-v2-f16), Word2Vec, S-ROBERTa, GloVe, FastText, CoVe, ELMO, and the like.

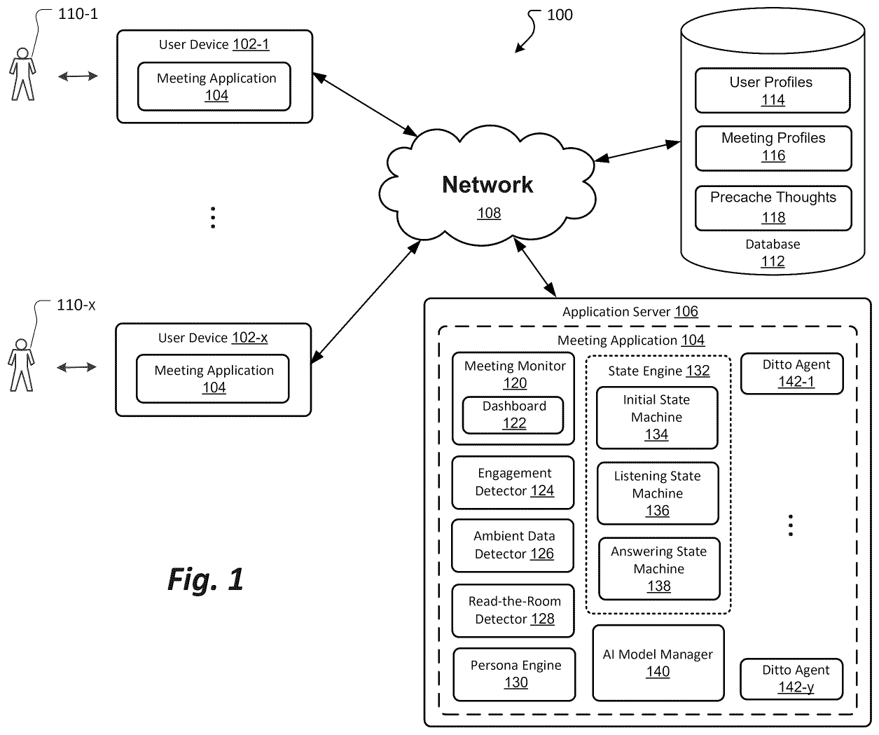

FIG. 1 illustrates an overview of an example system 100 in which personal digital agents (or “ditto agents 142”) may be dispatched to attend communication sessions, such as meetings, on behalf of users who may be personally unable to attend, in accordance with aspects of the present disclosure. A personal digital agent may be an intelligent application or processor that utilizes artificial intelligence (AI) approaches to provide the functionality described herein. Such intelligent digital agents may, for example, utilize models trained using user profile information to simulate personalized features (e.g., the persona) of a human, such as the visual appearance, voice, mannerisms, personality, expertise, knowledge and decision-making characteristics. Such an intelligent digital agent may also be trained based on meeting profile information representative of one or more previous meetings in which the user has participated, previous meetings between a particular group of participants, meeting etiquette and/or professionalism, and the like.

In aspects, system 100 may include one or more user devices 102 that may be configured to run or otherwise execute applications. The one or more user devices 102 may include, but are not limited to, laptops, tablets, desktop computers, smartphones, Internet-of-things (IoT) devices, and the like. The applications may have meeting features (“meeting applications 104”), which allow users to virtually attend various communication sessions, such as video conferencing communication sessions, audio conferencing communication sessions, streaming presentation sessions, and the like. Non-limiting examples of meeting applications 104 include Microsoft® Teams®, Microsoft® Skype™, Google® Mect®, Cisco® WebEx®, and Zoom®. In some examples, meeting applications 104 may include web versions, which run or otherwise execute instructions within web browsers, native client versions residing on the user devices 102, and/or server versions implemented on or by application server 106.

The one or more user devices 102 may be communicatively coupled to an application server 106 via network 108. Network 108 may be a wide area network (WAN), such as the Internet, a local area network (LAN), a radio access network (e.g., RAN), or any other suitable type of network. Network 108 may be a single public or private network, multiple integrated public or private networks, or a distributed public or private network (e.g., cloud network), in some examples. Meeting applications 104 may allow users 110 to virtually access various meetings, such as personal or business meetings, conferences, presentations, and the like, which may be hosted on or by the application server 106, for example.

System 100 may also include database 112 for storing information. Database 112 may be communicatively coupled to the application server 106 and/or to the one or more user devices 102 via the network 108, as illustrated in FIG. 1, or may be coupled to the application server 106 and/or to the one or more user devices 102 via any other suitable means, either now known or later developed. For example, database 112 may be directly connected to application server 106, communicatively coupled to application server 106, or integrated as part of application server 106, in examples. In various aspects, database 112 may be relational or non-relational databases, a graph database, an object-oriented database, or any combination of multiple databases thereof.

In further aspects, database 112 may store information associated with one or more user profiles 114, meeting profiles 116, and precache thoughts 118. Non-limiting examples of information associated with a user profile 114 includes images of the user, voice recordings of the user, statements made by the user (e.g., social media posts, electronic communications, documents authored by the user, recorded presentations, etc.), business roles and responsibilities of the user, personal and business calendar information, meeting context from the user (e.g., instructions or input regarding specific meeting topics, meeting goals or objectives, topics of interest, preparation notes for upcoming meetings, notes or observations from previous meetings, etc.), personal information (e.g., gender, ethnicity, educational background, geographic residence, skills, hobbies, activities, interests, food preferences or restrictions, etc.), and the like. In further aspects, a user profile 114 may include information about other people associated with a user 110. For example, a user profile 114 may include information about team members (e.g., names, birthdays, roles and responsibilities, professional relationships, collaborative projects, etc.), family members (e.g., names, birthdays, relationships, etc.), friends (e.g., names, birthdays, connections, mutual activities or interests, etc.), and the like. In some examples, an agent dashboard 124 may be utilized by the user to input or update information associated with a user profile 114.

Additionally, database 112 may include information associated with meeting profiles 116. Meeting profiles 116 may include information regarding previous or upcoming meetings, such as meeting titles, meeting descriptions, meeting agendas, meeting transcripts, meeting summaries, meeting action items, meeting invitees/declines/acceptances, meeting attendees, and the like. In some cases, meeting profiles 116 may also include up-to-date information regarding particular meeting topics (e.g., specific projects, initiatives, events, etc.) and statuses of associated topic metrics (e.g., timelines, benchmarks, deliverables, deadlines, action items, etc.).

In further examples, database 112 may include precached thoughts 118. Precached thoughts 118 may include pretrained statements associated with knowledge, expertise, or prepared content that the human (e.g., user 110) wishes to convey via the ditto agent 142 during the meeting. Additionally or alternatively, precached thoughts 118 may include fabricated statements for automatic output by the ditto agent 142 when latencies associated with artificial intelligence (AI) processing or waiting for a human response cause unnatural or awkward pauses in a meeting conversation. For example, while the ditto agent 142 is waiting for an answer, the ditto agent 142 may state: “Yes, let me think about that for a moment . . . ”; “Still thinking . . . ”; or “Let's move on and I will answer your question as soon as <human> is able to get back to me.” In aspects, different precached thoughts 118 may be appropriate in different scenarios and scenario triggers may be associated with one or more precached thoughts 118 to enable the ditto agent 142 to respond appropriately for a particular scenario. For example, some precached thoughts 118 may be associated with a first scenario trigger (e.g., “waiting for answer from human”) and other precached thoughts 118 may be associated with a second scenario trigger (e.g., “waiting for output from model). In some cases where latency is extended, the ditto agent 142 may provide more than one precached thought 118 in a particular scenario, for example, “Let me think about that for a minute,” and then, “Let's move on and I'll raise my hand when I have the answer for you.” In aspects, the ditto agent 142 may provide a precached thought 118 verbally or in a thought bubble associated with the agent avatar.

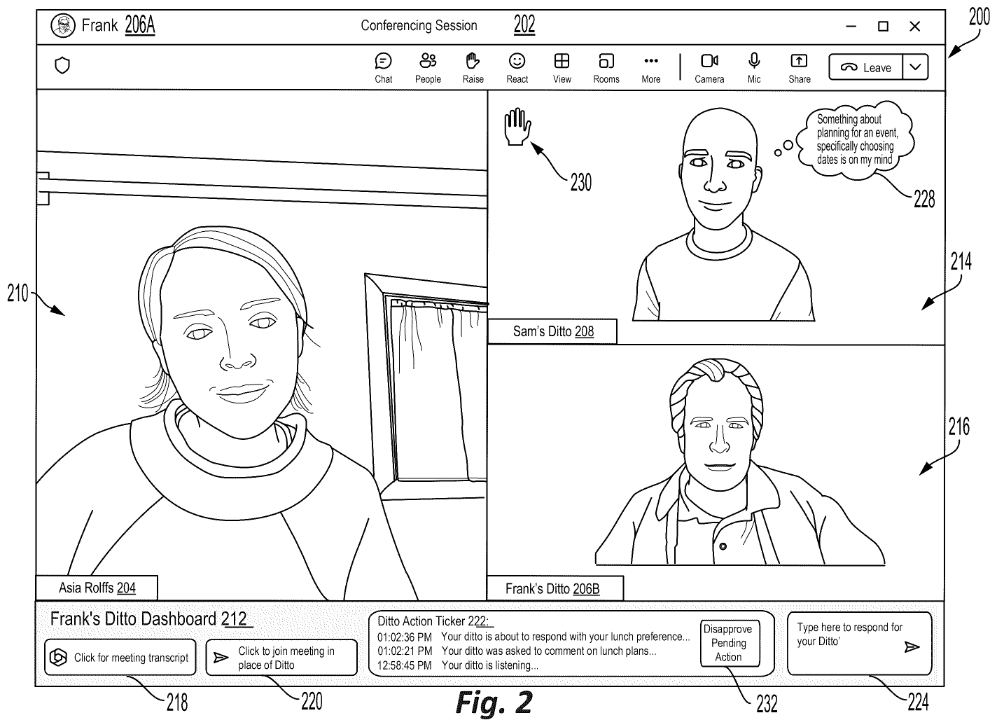

As illustrated by FIG. 1, application server 106 may include or be in communication with one or more components for implementing ditto agents 142. In some examples, application server may include a meeting application 104, which may include or be in communication with one or more components for implementing ditto agents 142. In aspects, each component may comprise software and/or hardware for implementing aspects of the functionality described herein. For example, meeting monitor 120 may include or be in communication with software and/or hardware (e.g., processors) configured to receive meeting input. Meeting input may refer to any raw or processed data collected during the meeting, including sounds, speech, images, video, text, etc. The meeting input may be received from devices (e.g., sensors, microphones, cameras, user devices 102, etc.), human interaction (e.g., speech or text via agent dashboard 122), software applications (e.g., implementing optical character recognition, gaze detection, speech-to-text, facial recognition, object recognition, etc.), and the like. In aspects, meeting monitor 120 receives meeting input continuously or at a regular time interval (e.g., every 100 milliseconds (ms), at 10 frames per second (fps), or based on a dynamic window). In further aspects, meeting monitor 120 may include or be in communication with agent dashboard 122. As described more fully with reference to FIG. 2, agent dashboard 122 may provide interface functionality to enable a human associated with the ditto agent 142 to exert direct supervision and control over agent actions, including fields for text input, microphones for speech input, and/or controls for joining the meeting or interceding for the ditto agent 142.

In addition to meeting monitor 120, application server 106 and/or meeting application 104 may include or be in communication with various detection components, including without limitation engagement detector 124, ambient data detector 126, and read-the-room detector 128. In aspects, the detection components may include or be in communication with one or more machine-learning models trained to detect various characteristics of a meeting based on meeting input received by meeting monitor 120. In some aspects, the one or more machine-learning models may include one or more foundation models. For example, engagement detector 124 may be configured or trained to detect when the ditto agent 142 is being engaged during a meeting. Engagement detector 124 may detect engagement based on direct communications (e.g., “Sam's Ditto, what do you think?”) or indirect communications (e.g., an eye gaze in the direction of the digital agent) with the ditto agent 142. In further aspects, engagement detector 124 may detect when the ditto agent 142 is being asked a direct question (e.g., “Sam's Ditto, when does Sam get back from his vacation?”). Ambient data detector 126 may be trained to detect ambient data based on the meeting input received by meeting monitor 120. For example, ambient data detector may detect non-verbal ambient audio (e.g., laughing, clapping, typing, dog barking, phone rings or chimes, etc.), verbal ambient audio (e.g., background conversations), or ambient visual information (e.g., people or things in video background, physical artifacts, etc.). Based on ambient data detected by ambient data detector 126 and/or meeting input received by meeting monitor 120, read-the-room detector 128 may be trained to infer characteristics of the meeting or meeting attendees, such as conversation mood (e.g., rude, argumentative, jovial, formal, casual, etc.), conversation flow (e.g., brainstorming, reporting, planning, presenting, etc.), attendec identification (e.g., based on voice or facial recognition), attendee engagement (e.g., attentive, distracted, disengaged, etc.), non-verbal communication or cues (e.g., proxemics, eye contact, facial expressions, body language, etc.), and the like.

Persona engine 130 may be configured to generate a ditto agent 142 to resemble a user 110 (e.g., a human person). For example, based on a user profile 114, persona engine 130 may utilize various generative models to simulate the mannerisms, personality, visual features, voice, word choice, etc., of the user 110. In aspects, the visual resemblance of the ditto agent 142 to the human may be on the spectrum between highly realistic (e.g., utilizing a generative model to manipulate videographic recordings of the human) to fanciful (e.g., utilizing diffusive techniques to create an avatar of the human). In further aspects, persona engine 130 may “puppet” the ditto agent 142 to mimic various gestures and facial features when communicating during the meeting. In this way, the ditto agent 142 is not only “human-like,” but epitomizes the actual human who is unable to attend the meeting, thereby encouraging more natural engagement with the ditto agent 142 and facilitating meeting productivity in the absence of a team member.

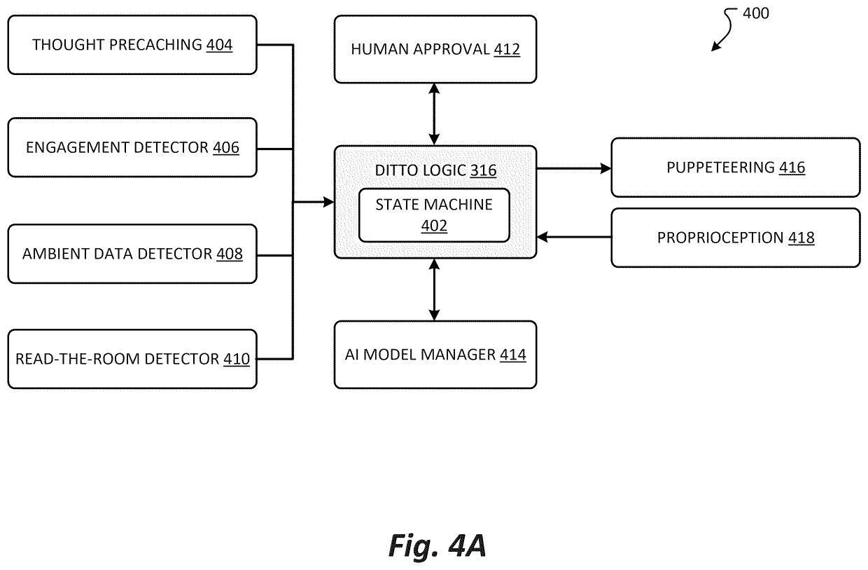

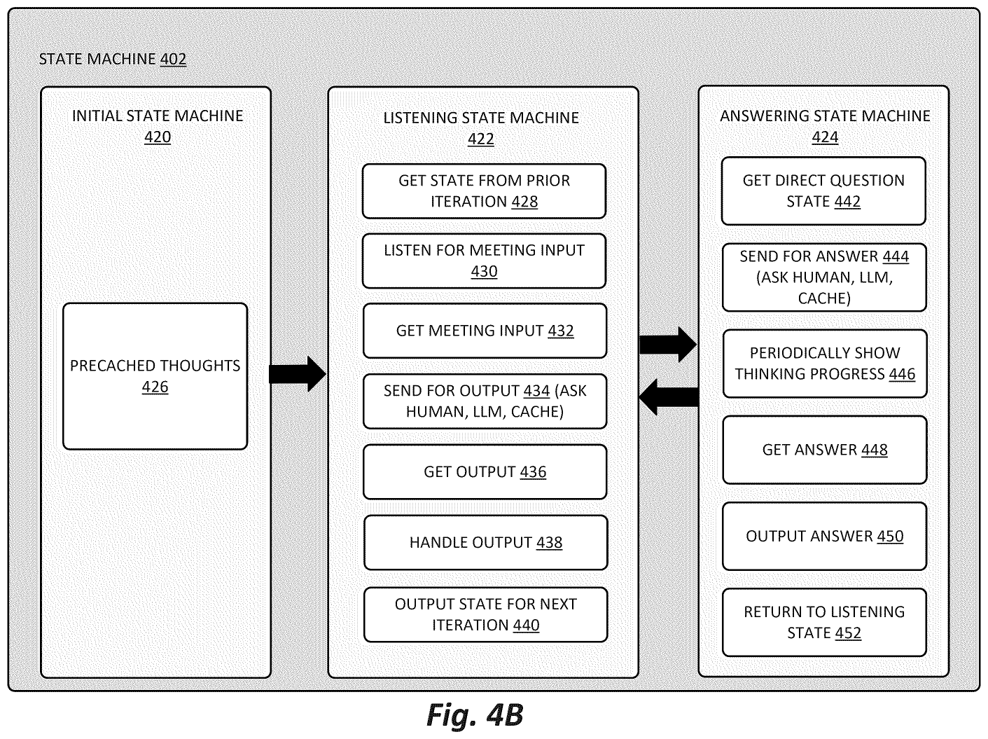

Application server 106 and/or meeting application 104 may further include or be in communication with a state engine 132 for processing meeting input and determining actions for ditto agent 142. In aspects, state engine 132 is in communication with artificial intelligence (AI) model manager 140 for selecting and querying various ML models to process the meeting input and output appropriate actions for the ditto agent 142. State engine 132 may be associated with a “thought loop” that is called at regular intervals (e.g., every 100 milliseconds (ms), at 10 frames per second (fps), or based on a dynamic window). State engine 132 may be a “stateless machine,” where each frame gets its state from the previous iteration and outputs its state to the next iteration. Further, each frame gets meeting input and sends out new output, which may include sending requests to a ML model or a human, for example, and getting responses from previous requests. State engine 132 may further be replayable, enabling feedback and fine-tuning of the system. For example, the inputs, outputs, state in, and state out for each frame may be recorded and replayed to perform live debugging. As described further with respect to FIG. 4B, state engine 132 may include an initial state machine 134, a listening state machine 136, and an answering state machine 138. Initial state machine 134 may be pretrained with precached thoughts 118 for providing context or priming the listening state machine 136. In aspects, listening state machine 136 gets “state in” from the previous frame, gets meeting input, sends for output, gets output and sends “state out” to the next frame. Answering state machine 138 may receive a direct question state, send for an answer, get the answer, output the answer, and return to the listening state machine 136.

Listening state machine 136 and/or answering state machine 138 may be in communication with AI model manager 140, which may select and query one or more ML models in response to a request for output. In some examples, AI model manager 140 may be in communication with (e.g., via various application programing interfaces, APIs) a library of ML models trained for specific tasks and may select an appropriate ML model based on the request. In other examples, AI model manager 140 may be in communication with one or more foundation (or generative) models, which may be more generally adapted to provide output for a broad range of tasks. AI model manager 140 may be further adapted to generate prompts for querying the models, which prompts may further include context in addition to the meeting input. In aspects, context may include information from user profiles 114, meeting profiles 116, meeting transcripts or summaries, or any other context for conditioning (or priming) the ML model to provide appropriate output to a request.

As noted above, the AI manager 140, the listening state machine 136 and/or answering state machine 138 may process input based on a “thought loop.” For example, a large prompt may be generated including information regarding the persona of the user 110, and as the meeting continues, the prompt may be updated with additional input and generative determinations regarding meeting progress. For example, in addition to the meeting input received at each iteration, the prompt may be updated with a real-time meeting transcript or meeting summary including the topics covered thus far. With each iteration of the thought loop, the updated prompt may be fed into one or more foundation or other ML models to generate output. In some cases, the model output may indicate that no action is to be taken and the loop may return to the listening state machine for the next iteration. In other examples, model may output an action to be performed by the digital agent. The action may then be implemented (or “puppeted”) by the digital agent (e.g., raise hand, show thought bubble, ask user, provide response, etc.). Following the puppeted action, the digital agent may store its proprioception (e.g., sense of position or movement) as state information for the next iteration.

In some cases, the model may further output a time to respond. If the model output is not returned within the allotted time, a precached thought may be provided (e.g., “Still thinking”), for example, to minimize latency interruptions in conversation flow. In a specific example, the model may detect that the digital agent is being asked a direct question. In this case, the thought loop may progress to the answering state machine 138 for information (answer) gathering or retrieval. In other examples, retrieval augmented generation (RAG) may be utilized to obtain an answer from external sources. In other examples, the answer may be returned based on user profile or other personalized or stored information. In still other examples, the digital agent may deem it necessary to request direct input from the user.

As illustrated by FIG. 1, the system may generate multiple ditto agents 142 (e.g., ditto agent 142-1 to ditto agent 142-y), with each ditto agent 142 corresponding to a particular human (e.g., user 110-1 to user 110-x) based at least in part on a user profile 114. As noted above, the ditto agent 142 generated for a particular human may resemble the human in a number of ways, e.g., mannerisms, visual appearance, voice, word choice, etc. Additionally, the ditto agent 142 may be able to “read-the-room” and adapt its actions accordingly. For example, the ditto agent 142 may be configured to detect meeting interaction characteristics and dynamically adapt how it interacts. That is, the ditto agent 142 may be able to detect that the meeting is less interactive (e.g., a presentation) or more interactive (e.g., strategy, brainstorming) and may dynamically adjust its degree of interaction during the meeting. By way of another example, the ditto agent 142 may be able to detect more formal meetings or more casual meetings. That is, the ditto agent 142 may embody more professional behavior during an all-company meeting or a meeting with superiors of user 110 and more casual behavior during a brainstorming meeting with a project team. As should be appreciated, ditto agent 142 may be continuously trained and finetuned to improve its human-like presence during a meeting in order to foster a richer and more productive meeting experience for human attendees.

FIG. 2 depicts a meeting interface 200 hosted by a meeting application (e.g., meeting application 104 of FIG. 1) running on or accessed by a computing device (e.g., user device 102) associated with a first non-attending user 206A (“Frank”) of a video conferencing session 202. As illustrated, user interface 200 displays one frame of conferencing session 202. While in this example conferencing session 202 is viewable on the computing device of the first non-attending user 206A, the first non-attending user 206A may not be directly participating in conferencing session 202. In other examples, conferencing session 202 may not even be open on the computing device of the first non-attending user 206A.

As further shown by FIG. 2, an attending user 204 (“Asia”) is displayed in a first panc 210 of the user interface 200, first ditto agent 206B (corresponding to first non-attending user 206A, “Frank”) is displayed in a second pane 216 of the user interface 200, and second ditto agent 208 (corresponding to a second non-attending user, “Sam”) is displayed in a third pane 214 of the user interface 200. In this example, the first ditto agent 206B has a realistic visual resemblance to the first non-attending user 206A (“Frank”) and the second ditto agent 208 has a more fanciful (or cartoonish) resemblance to a second non-attending user. As further illustrated by FIG. 2, second ditto agent 208 is displayed with thought bubble 228, which informs the other attendees that the second ditto agent 208 has determined that the meeting involves planning an event and that the current topic of conversation has to do with choosing dates for the event. In another aspect, when the digital agent is unable to answer a question posed during the meeting, thought bubble 228 may state, for example, “I don't have the answer to that right now, but I will follow-up with an answer after the meeting.” Additionally, the second ditto agent 208 is raising its hand 230, indicating to the other attendees that the second ditto agent 208 would like to engage in the meeting conversation. Although not shown, the second ditto agent 208 may have determined to convey unavailable dates for the second non-attending user, suggest available dates for the second non-attending user, or otherwise comment on the topic at hand.

As shown, the ditto dashboard 212 is provided via meeting interface 200. In other examples, the ditto dashboard 212 may run in a separate interface, which is accessible upon demand and/or notifies the first non-attending user 206A when relevant meeting information or questions are detected during conferencing session 202 (e.g., by surfacing a popup window). Ditto dashboard 212 provides non-limiting examples of interface functionalities for enabling the first non-attending user 206A to have a varying degree of control over the first ditto agent 206B during conferencing session 202. For example, ditto action ticker 222 may provide real-time updates regarding what the first ditto agent 206B is thinking about (e.g., requests to models) and/or about to do (e.g., proposed actions based on model outputs).

In some aspects, a disapprove button 232 enables the first non-attending user 206A to intercede and prevent a proposed action from being taken by the first ditto agent 206B. In other aspects, text field 224 may enable the first non-attending user 206A to directly input a response (or action) for the first ditto agent 206B. Additional non-limiting functionalities may include button 218 for retrieving a real-time transcript of the conferencing session 202 or join button 220 enabling the first non-attending user 206A to join the conferencing session 202 in place of the first ditto agent 206B. As should be appreciated, the described examples of interface functionality are non-limiting and other functionalities may be provided, such as buttons for viewing a meeting summary, initiating a microphone for speaking into the conferencing session, or the like.

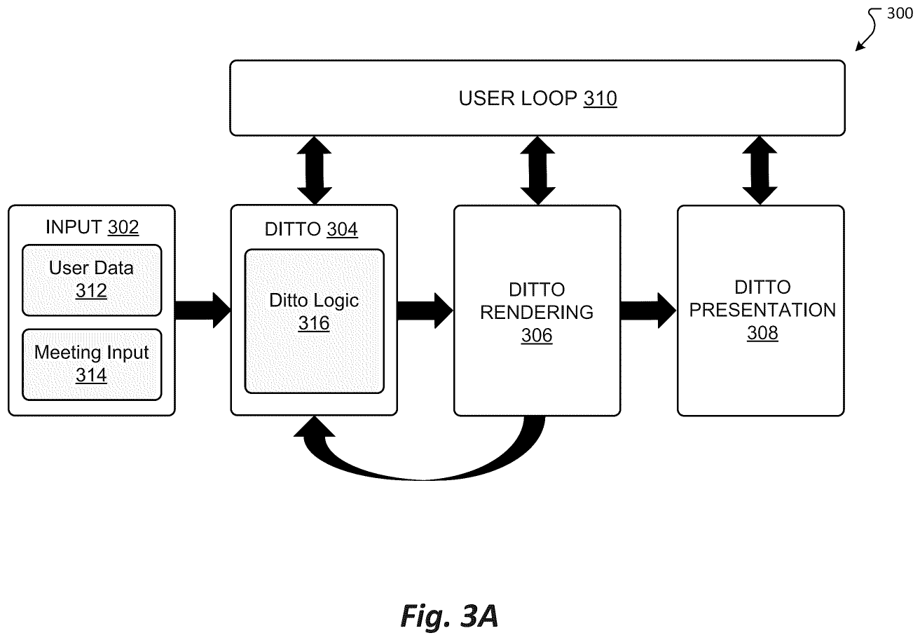

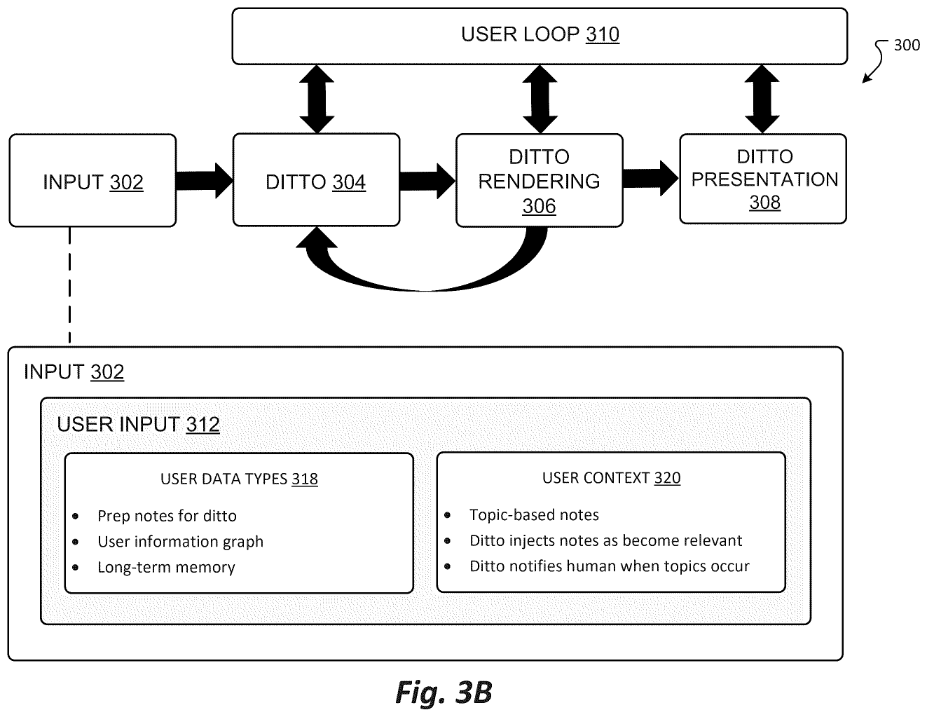

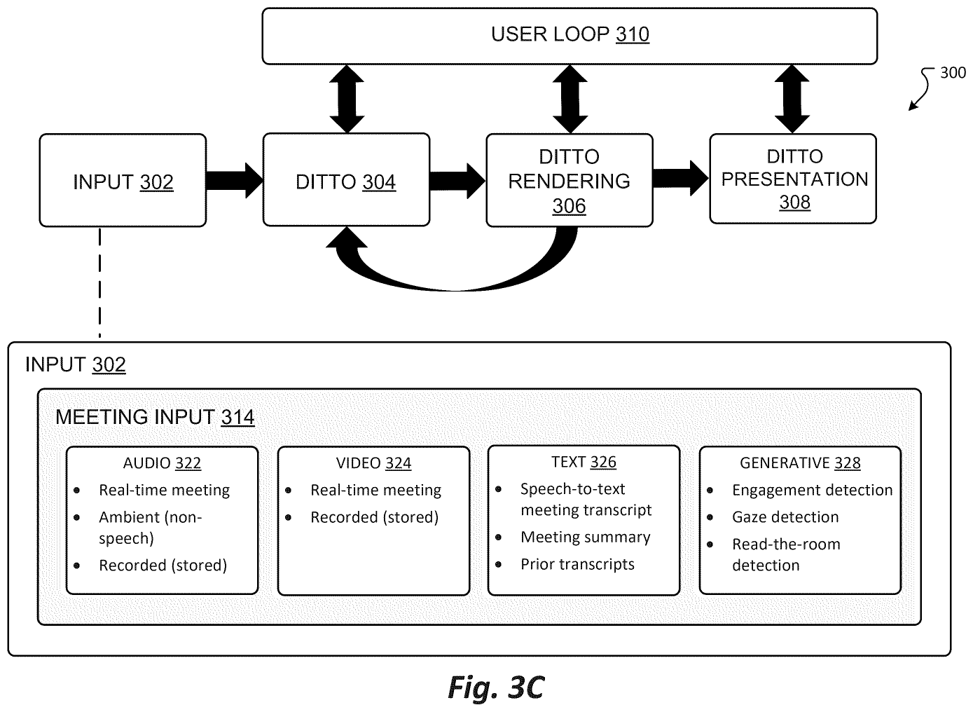

FIGS. 3A-3C illustrate an overview of an example conceptual architecture 300 for implementing personal digital agents, according to aspects described herein.

As illustrated conceptual architecture 300 of FIG. 3A, input 302 (including user data 312 and meeting input 314) may be fed into ditto component 304, which includes ditto logic 316. Based on processing input 302, ditto rendering component 306 generates a digital agent having a persona associated with a particular user. For example, the digital agent may be rendered to resemble the visual appearance, mannerisms, personality, voice, knowledge, expertise, word choice, etc., of the particular user. In this way, the digital agent is designed not only to act on behalf of the particular user during the meeting, but to portray a likeness of the particular user within the meeting. As the meeting progresses, the ditto rendering component 306 and the ditto component 304 form a processing loop so that the rendering of the digital agent keeps pace with the receipt and processing of incoming input 302, including detected conditions, determinations, proposed actions, responses, answers, etc., output by models associated with ditto logic 316. In aspects, the rendering of an action may be based on the persona of the user. For example, an audio rendering of an action may include the digital agent posing or answering a question in a voice simulating the human, a visual rendering of an action may include the digital agent posing or answering a question using hand gestures or facial expressions simulating the human, and an audio-visual rendering may include a combination of audio-visual traits of the human. User loop 310 may be associated with a sandbox and/or dashboard for training or controlling the digital agent before, during, and/or after the meeting. For example, the user loop 310 enables pretraining (e.g., precached thoughts, preparation for specific topics or a specific meeting), testing (e.g., based on prerecorded meetings to evaluate performance), feedback (e.g., finetuning of agent interactions, evaluation of response relevance and/or accuracy, finetuning of persona rendering, etc.), and/or in-meeting control or redirection. During the meeting, the non-attending user may determine to join the meeting at any time. In some aspects, ditto presentation component 308 enables the human user to join the meeting as a “picture-in-picture” (PIP) in the same pane as the digital agent. In other aspects, ditto presentation component 308 enables the human user to fully displace the digital agent within the meeting interface (e.g., within the pane occupied by the digital agent) and enter the meeting as a participant (or attendee).

FIG. 3B illustrates the types of user data 318 and user context 320 that may be received as user input 312. For example, user data types 318 may include without limitation notes provided by the user in preparation for a meeting, user profile information (e.g., user profile 114) that may be provided via a graph or other database (e.g., database 112), and/or long-term memory information (e.g., information collected and stored by the digital agent). For example, long-term memory may include a history of conversation topics covered and decisions made during the meeting (e.g., Mexican food was discussed and declined), proprioception (e.g., the digital agent's sense of its position and movements), previously gathered information (e.g., via retrieval augmented generation), precached thoughts, and the like. User context 320 may include without limitation topic-based notes (e.g., the user's opinions or input regarding specific topics that may arise in the meeting), ditto-injected notes (e.g., information deemed relevant by the digital agent during the meeting), and direct user input (e.g., user responses to ditto notifications regarding requests, queries, occurrence of topics, or information deemed relevant).

FIG. 3C illustrates non-limiting examples of meeting input 314. As noted above, meeting input may be received continuously or at regular intervals. The types of meeting input 314 that may be received and/or detected include audio input 322, video input 324, text input 326, and/or generative output 328. For example, audio input 322 may include without limitation a real-time audio meeting recording, ambient or non-speech audio, prerecorded (stored) audio, and the like. Video input 324 may include without limitation a real-time video meeting recording, prerecorded (stored) video, and the like. Text input 326 may include without limitation a speech-to-text meeting transcript, a generated meeting summary, prior meeting transcripts or summaries, documents, social media posts, texts, chats, and the like. Generative output 328 may include without limitation determinations made by one or more ML models, such as engagement detection (e.g., determinations that the digital agent is being engaged by other attendees to the meeting), gaze detection (e.g., detection of eye gaze in the direction of the digital agent), read-the-room detection (e.g., determinations regarding conversation mood, conversation flow, interaction level, etc.). As should be appreciated, the system may receive any of a variety of input, such as raw data, processed data, generative data, stored data, retrieval augmented data, and the like.

FIGS. 4A-4B illustrate an overview of an example conceptual architecture 400 of a state machine 402 for implementing personal digital agents, according to aspects described herein.

As illustrated by FIG. 4A, ditto logic 316 comprises a state machine 402 (e.g., similar to state engine 132), described further with respect to FIG. 4B. In addition to receiving meeting input 314 (see FIG. 3A), ditto logic 316 may receive training data, such as precached thoughts 404. Similar to precached thoughts 118, Precached thoughts 404 may include pretrained statements associated with knowledge, expertise, or prepared content that a user wishes to convey via the digital agent during the meeting. Additionally or alternatively, precached thoughts 404 may include fabricated statements for automatic output by the digital agent when latencies associated with artificial intelligence (AI) processing or waiting for human responses cause unnatural or awkward pauses in a meeting conversation. In aspects, different precached thoughts 404 may be appropriate in different scenarios and scenario triggers may be associated with one or more precached thoughts 404 to enable the digital agent to respond appropriately for a particular scenario. In some cases where latency is extended, the digital agent may provide more than one precached thought 404 in a particular scenario.

Ditto logic 316 may also incorporate generative input from various detection components, including an engagement detector 406, an ambient data detector 408, and a read-the room detector 410. In aspects, detection components may include or be in communication with one or more machine-learning models trained to detect various characteristics of a meeting based on meeting input 314, for example. In some aspects, the one or more machine-learning models may include one or more foundation models. For example, engagement detector 406 (e.g., the same or similar to engagement detector 124) may be configured or trained to detect when the digital agent is being engaged during a meeting. Engagement detector 406 may detect engagement based on direct communications (e.g., “Sam's Ditto, what do you think?”) or indirect communications (e.g., an eye gaze in the direction of the digital agent) with the digital agent. In further aspects, engagement detector 406 may detect when the digital agent is being asked a direct question (e.g., “Sam's Ditto, when does Sam get back from his vacation?”). Ambient data detector 408 (e.g., the same or similar to ambient data detector 126) may be trained to detect ambient data based on meeting input 314. For example, ambient data detector may detect non-verbal ambient audio (e.g., laughing, clapping, typing, dog barking, phone rings or chimes, etc.), verbal ambient audio (e.g., background conversations), or ambient visual information (e.g., people or things in video background, physical artifacts, etc.). Based on ambient data detected by ambient data detector 408, read-the-room detector 410 (e.g., the same or similar to read-the-room detector 128) may be trained to infer characteristics of the meeting or meeting attendees, such as conversation mood (e.g., rude, argumentative, jovial, formal, casual, etc.), conversation flow (e.g., brainstorming, reporting, planning, presenting, etc.), attendee identification (e.g., based on voice or facial recognition), attendee engagement (e.g., attentive, distracted, disengaged, etc.), non-verbal communication or cues (e.g., proxemics, eye contact, facial expressions, body language, etc.), and the like.

As noted above with respect to user loop 310, ditto logic 316 and/or state machine 402 may receive human input (e.g., human approval 412) at any time. In aspects, human intervention and/or oversight into the digital agent may run the gamut from passive to full control and may be received before, during, and/or after a meeting.

Ditto logic 316 and/or state machine 402 may include or be in communication with an AI model manager 414 (e.g., the same or similar to AI model manager 140), which may select and query appropriate ML models in response to a request for output. In some examples, AI model manager 414 may be in communication with (e.g., via various APIs) a library of ML models trained for specific tasks and may select an appropriate ML model based on the request. In other examples, AI model manager 414 may be in communication with one or more foundation (or generative) models, which may be more generally adapted to provide output for a broad range of tasks. AI model manager 414 may be further adapted to generate prompts for querying the models, which prompts may further include context in addition to the meeting input. In aspects, context may include personal information, meeting information, or any other context for conditioning (or priming) the ML model to provide appropriate output to a request. When an ML model outputs an action to be taken by the digital agent, a puppeteering component 416 may cause the digital agent to perform the action (e.g., raise hand, display thought bubble, verbally deliver answer, or the like). Thereafter, the digital agent's sense of position or movement may be stored by proprioception component 418 and provided as state information to the next iteration.

FIG. 4B illustrates a conceptual architecture 400 of state machine 402. State machine 402 (e.g., the same or similar to state engine 132) may be in communication with AI model manager 414 (FIG. 4A) for selecting and querying various ML models to process meeting input and output appropriate actions for the digital agent. State machine 402 may implement a “thought loop” that is called at regular intervals (e.g., every 100 milliseconds (ms), at 10 frames per second (fps), or based on a dynamic window). State machine 402 may be a “stateless machine,” where each frame gets its state from the previous iteration and outputs its state to the next iteration. Further, each frame gets meeting input and sends out new output, which may include sending requests to a ML model or a human, for example, and getting responses from previous requests. State machine 402 may further be replayable, enabling fine-tuning of the system. For example, the inputs, outputs, state in, and state out for each frame may be recorded and replayed to perform live debugging. As illustrated, state machine 402 includes initial state machine 420, listening state machine 422, and answering state machine 424. In aspects, initial state machine 420 may be primed with precached thoughts 426 for providing context to listening machine 422. For example, listening state machine 422 may get initial context from initial state machine 420, get “state in” from the previous frame 428, listen for meeting input 430, get meeting input 432, send for output based on the meeting input 434, get output 436, handle the output 438, and send “state out” to the next frame 440. As a special case, the thought may loop to the answering state machine 424 upon detection of a direct question (e.g., getting a direct question state 442). The answering state machine 424 may then send for an answer 444 (e.g., a RAG request), periodically show thinking progress 446 (e.g., when latency may cause an unnatural pause in the conversation), get the answer 448, output the answer 450, and return to the listening state 452 associated with listening state machine 422.

With further reference to the thought loop, a large prompt may be generated including information regarding the persona of the non-attending user, and as the meeting continues, the prompt may be updated with additional input and generative determinations regarding meeting progress. For example, in addition to the meeting input received at each iteration, the prompt may be updated with a real-time meeting transcript or meeting summary including the topics covered thus far. With each iteration of the thought loop, the updated prompt may be fed into one or more foundation or other ML models to generate output. In some cases, the model output may indicate that no action is to be taken and the loop may return to the listening state machine for the next iteration. In other examples, the model may output an action to be performed by the digital agent. The action may then be implemented (or “puppeted”) by the digital agent (e.g., raise hand, show thought bubble, ask user, provide response, etc.). In aspects, the action may be puppeted to simulate mannerisms, gestures, or features of the user. Following the puppeted action, the digital agent may store its proprioception (e.g., sense of position or movement) as state information for the next iteration.

FIGS. 5A-5C illustrate an overview of an example method 500 for implementing personal digital agents, according to aspects described herein.

FIG. 5A illustrates method 500A, which begins at instantiate operation 502, where a digital agent is instantiated with a persona of a user (e.g., a human) to act on behalf of the user. For example, one or more generative models may instantiate the digital agent based on personal attributes and information associated with the user. Utilizing models trained using user profile information, the digital agent may be instantiated to simulate personalized features (e.g., the persona) of a human, such as the visual appearance, voice, mannerisms, personality, expertise, knowledge and decision-making characteristics. The digital agent may also be trained based on meeting profile information representative of one or more previous meetings in which the user has participated, previous meetings between a particular group of participants, meeting etiquette and/or professionalism, and the like.

At receive indication operation 504, an indication to dispatch the digital agent to a meeting on behalf of the user may be received. In some aspects, the digital agent may be automatically dispatched to a meeting in response to determining that the user is unable to attend. In other aspects, the user may make a selection to dispatch the digital agent to the meeting on their behalf. Since the digital agent takes on the persona (e.g., personality, mannerisms, preferences, knowledge, and in some cases, a realistic visual appearance and voice of the human), the digital agent is able to effectively interact on behalf of the human in the meeting.

At monitor operation 506, the digital agent may monitor the meeting. For example, the digital agent may call a listening state machine to monitor for meeting input continuously or at regular intervals. On a loop, listening state machine gets “state in” from the previous frame, gets meeting input, sends for output, gets output and sends “state out” to the next frame.

At determination operation 508, it is determined whether meeting input has been received. Non-limiting examples of the types of meeting input that may be received and/or detected include audio input, video input, text input, and/or generative output. Audio input may include without limitation a real-time audio meeting recording, ambient or non-speech audio, prerecorded (stored) audio, and the like. Video input may include without limitation a real-time video meeting recording, prerecorded (stored) video, and the like. Text input may include without limitation a speech-to-text meeting transcript, a generated meeting summary, prior meeting transcripts or summaries, documents, social media posts, texts, chats, and the like. If meeting input was not received, the method may return to monitor operation 506. If meeting input was received, the method may progress to process operation 510.

At process operation 510, the meeting input may be processed by one or more machine learning models. In some examples, based on the meeting input, a ML model trained for specific tasks may be selected (e.g., a ML model trained to detect eye gaze). In other examples, based on the meeting input, a foundation model trained on a wide variety of topics for a wide variety of tasks may be selected (e.g., a foundation model for determining a mood of a conversation). In further examples, a prompt may be generated including information regarding the persona of the user 110, and as the meeting continues, the prompt may be updated with additional input and generative determinations regarding meeting progress. For example, in addition to the meeting input received at each iteration, the prompt may be updated with a real-time meeting transcript or meeting summary including the topics covered thus far. With each iteration of the thought loop, the updated prompt may be fed into one or more foundation or other ML models to generate output.

At receive output operation 512, model output may be received from the one or more ML models. Model output may include any of a variety of output types, such as an answer to a question, detection of a condition (e.g., ambient audio, digital agent engagement), a determination regarding a condition (e.g., conversation mood), an action (e.g., raise hand, display thought bubble), a question (e.g., a clarifying question), and the like.

At determination operation 514, it may be determined whether the model output indicates action should be taken by the digital agent. In some cases, the model output may indicate that no action is to be taken and the loop may return to the listening state machine at monitor operation 506. Otherwise, the method may advance to operation 516.

At operation 516, based on the model output, it may be determined how the digital agent should respond (or what action should be performed). For example, if the model output indicates that the digital agent was asked a question in a rude manner, it may be determined that the digital agent should smile and respond with, “Please ask nicely,” rather than requesting an answer to the question. By way of another example, if the model output is a response to a query, it may be determined that the digital agent should raise its hand. In aspects, determining the action includes determining a rendering for puppeting the digital agent to perform the action (e.g., raising its hand). As should be appreciated, model output may suggest any of a vast number of responses to be taken by the digital agent. Indeed, the model output itself may be fed into another model to determine an appropriate responsive action to the output.

At cause operation 518, the digital agent may be puppeted by the system to perform the determined action. Continuing with the examples above, a generative model may cause the digital agent to verbally utter the phrase, “Please ask nicely,” or may cause the digital agent to raise one of its arms with the palm of its hand towards the audience. Until an indication that the meeting has ended or the digital agent has been excused from the meeting (e.g., replaced by the user), the method may continue to loop back to monitor operation 506.

FIG. 5B illustrates method 500B, which illustrates further details with respect to instantiate operation 502 of FIG. 5A.

At receive operation 502A, user data and/or context may be received. Non-limiting examples of user data may include personal information (e.g., gender, ethnicity, educational background, geographic residence, skills, hobbies, activities, interests, food preferences or restrictions, etc.), images of the user, voice recordings of the user, statements made by the user (e.g., social media posts, electronic communications, documents authored by the user, recorded presentations, etc.), business roles and responsibilities of the user, personal and business calendar information, and the like. Non-limiting examples of context may include instructions or input regarding specific meeting topics, meeting goals or objectives, topics of interest, preparation notes for upcoming meetings, notes or observations from previous meetings, for example.

At generate operation 502B, an agent persona may be generated. For example, based on the user data and context, a persona may be generated that epitomizes the mannerisms, voice, personality, word choice, and gestures of the user.

At generate operation 502C, a visual rendering of the digital agent may be generated. In some aspects, the visual rendering may be on a scale from highly realistic (e.g., utilizing generative models to manipulate videographic recordings of the user) to fanciful (e.g., using diffusive techniques to render an avatar resembling the user).

At provide operation 502D, an agent sandbox may be provided. The agent sandbox may be an interactive interface, for example, for accepting user input and feedback on the digital agent persona and/or rendering.

At test operation 502E, the digital agent may be tested. For example, meeting recordings can be used to test model processing and agent responses.

At receive operation 502F, feedback may be received to the sandbox based on the testing.

At update operation 502G, the agent persona, rendering, and/or model processing may be updated and finetuned via the agent sandbox.

In aspects, upon preparing the digital agent using the agent sandbox, the method may return to instantiate operation 502 of FIG. 5A.

FIG. 5C illustrates method 500C, which illustrates further details with respect to operations 510-514 of FIG. 5A.

At generate operation 509, a prompt based on meeting input and context may be generated. For example, a large prompt may be generated including information regarding the persona of the user and, as the meeting continues, the prompt may be updated with additional input and generative determinations regarding meeting progress. For example, in addition to the meeting input received at each iteration, the prompt may be updated with a real-time meeting transcript or meeting summary including the topics covered thus far. With each iteration of the thought loop, the updated prompt may be fed into one or more foundation or other ML models to generate output.

At process operation 511, the prompt may be processed by one or more ML models to generate model output. Based on the prompt, a ML model trained for specific tasks may be selected (e.g., a ML model trained to detect eye gaze). In other examples, based on the meeting input, a foundation model trained on a wide variety of topics for a wide variety of tasks may be selected (e.g., a foundation model for determining the mood of a conversation).

At receive output operation 512, model output may be received from the one or more ML models. Model output may include any of a variety of output types, such as an answer to a question, detection of a condition (e.g., ambient audio, digital agent engagement), a determination regarding a condition (e.g., conversation mood), an action (e.g., raise hand, display thought bubble), a question (e.g., a clarifying question), and the like.

At determination operation 513A, it may be determined whether the output is relevant. In some examples, the model output may be fed into another ML model to determine relevance. In aspects, relevance may be based on a difference between the model output and meeting attributes, e.g., topics discussed, subject matter, meeting transcript, meeting summary, and the like. If the model output is not reasonably related to the meeting, it may be determined that the model output is irrelevant, and the method may return to monitor operation 506. If the model output is not irrelevant, the method may advance to determination operation 513B.

At determination operation 513B, it may be determined whether the model output indicates that the digital agent is being explicitly engaged within the meeting. For example, if the meeting input is a statement addressing the digital agent directly by name, the model output may indicate that the digital agent is being explicitly engaged. If the digital agent is being explicitly engaged, the method may advance to determine operation 516 to determine how the digital agent should respond. If the digital agent is not being explicitly engaged, the method may progress to determination operation 513C.

At determination operation 513C, it may be determined whether ambient data has been detected. Non-limiting examples of ambient data include non-verbal ambient audio (e.g., laughing, clapping, typing, dog barking, phone rings or chimes, etc.), verbal ambient audio (e.g., background conversations), or ambient visual information (e.g., people or things in video background, physical artifacts, etc.). If ambient data was detected, the method may advance to determine operation 513D. If ambient data was not detected, the method may advance to determination operation 514, where it may be determined whether an action should be taken by the digital agent.

At determine operation 513D, based on the detected ambient data, characteristics regarding the meeting or meeting attendees may be determined. Meeting characteristics may include conversation mood (e.g., rude, argumentative, jovial, formal, casual, etc.), conversation flow (e.g., brainstorming, reporting, planning, presenting, etc.), attendee identification (e.g., based on voice or facial recognition), attendee engagement (e.g., attentive, distracted, disengaged, etc.), non-verbal communication or cues (e.g., proxemics, eye contact, facial expressions, body language, etc.), and the like.

At determination operation 513E, based on the determined meeting characteristics, it may be determined whether the digital agent has been implicitly engaged. For example, if the model output indicates eye gaze in the direction of the digital agent, it may be inferred that the digital agent is being implicitly engaged. If it is determined that the digital agent is being implicitly engaged, the method may advance to determine operation 516, where it is determined how the digital agent should respond. If it is determined that the digital agent is not being implicitly engaged, the method may advance to determination operation 514, where it is determined whether action should be taken by the digital agent.

As should be appreciated, operations 502-518 are described for purposes of illustrating the present methods and systems and are not intended to limit the disclosure to a particular sequence of steps, e.g., operations may be performed in a different order and more or fewer operations may be performed without departing from the present disclosure.

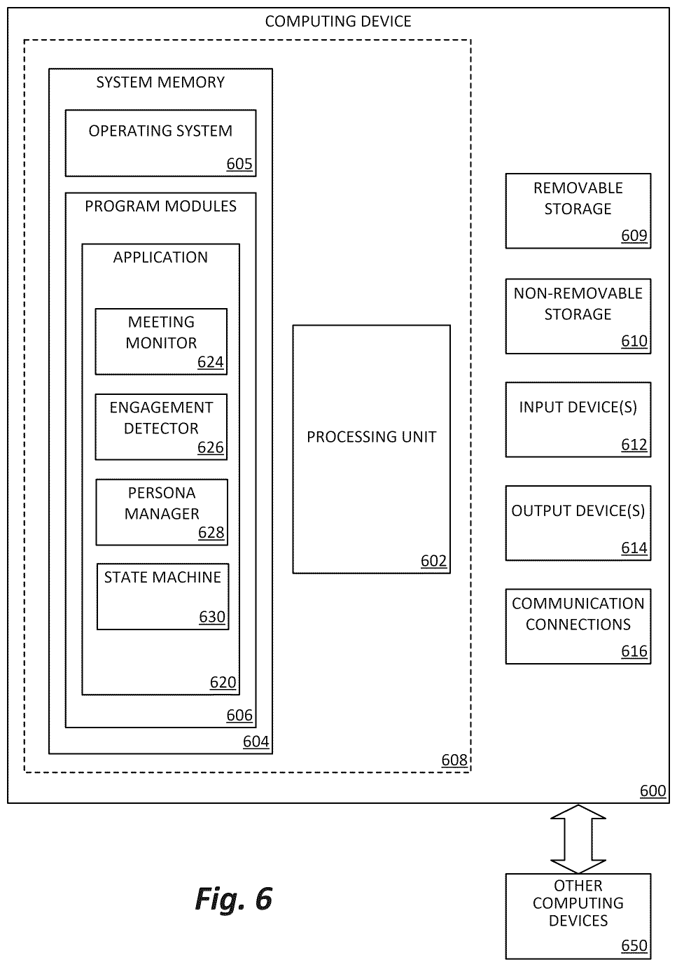

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more computing devices (e.g., user devices 102, application server 106) discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, an application 620 (e.g., meeting application) may run various modules to perform functionalities described herein, such as an meeting monitor 624, engagement detector 626, persona manager 628, an/or state machine 630. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include metric monitors, definition databases, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

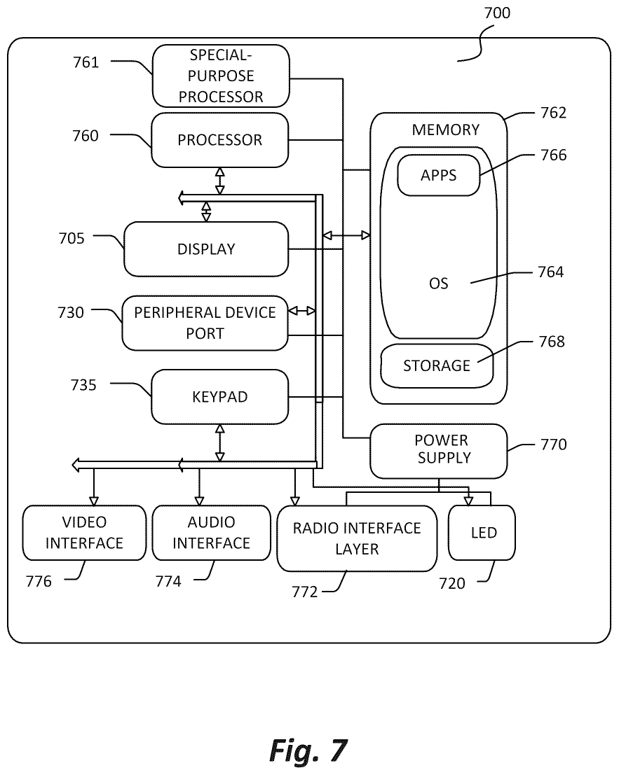

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, conferencing programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

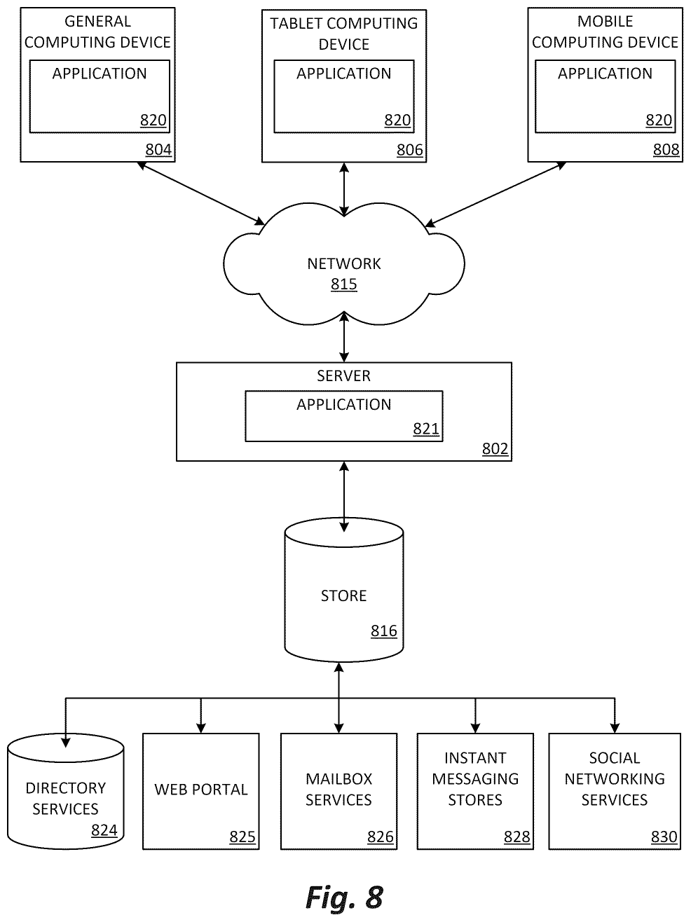

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

An application 820 (e.g., similar to application 620) may be employed by a client that communicates with server device 802. Additionally, or alternatively, application 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In an aspect, a system including at least one processor and memory storing instructions that, when executed by the at least one processor, cause the system to perform a set of operations is provided. The set of operations include instantiating a digital agent with a persona associated with a user and receiving an indication to dispatch the digital agent to a virtual meeting on behalf of the user. The set of operations further include monitoring the virtual meeting, receiving first meeting input, and processing, by a first foundation model, the first meeting input to generate first output. Based on the first output, the set of operations included determining a first action and determining a first rendering for the first action. Additionally, the set of operations includes causing the digital agent to perform the first action on behalf of the user according to the persona and the determined first rendering.

In further aspects, the persona is associated with a realistic representation of the user, a fanciful representation of the user, or any of a range of representations therebetween. Additionally, the monitoring occurs continuously, at a regular time interval, or over a dynamic window. In further aspects, the determined first rendering of the first action is an audio rendering, a visual rendering, or an audio-visual rendering. The set of operations also includes receiving second meeting input and processing, by a second foundation model, the second meeting input to generate second output. Based on the second output, determining a second action and determining a second rendering for the second action. Additionally, causing the digital agent to perform the second action on behalf of the user according to the persona and the determined second rendering. In further aspects, the first foundation model is one of the same or different from the second foundation model. Additionally, the determined first rendering of the first action is based at least in part on the persona. In further aspects of the system, determining the first action comprises one of asking the user, querying the same or different foundation model, or selecting a precached thought. The set of operations also includes, in response to the digital agent performing the first action, detecting a proprioception of the digital agent and storing the proprioception.

In another aspect, a method of using one or more foundation models to instantiate a digital agent is provided. The method includes instantiating a digital agent with a persona associated with a user, where the persona is associated with at least a speech simulation and visual representation resembling the user, and receiving an indication to dispatch the digital agent to a virtual meeting on behalf of the user. Additionally, the method includes monitoring the virtual meeting, receiving meeting input, and processing, by a foundation model, the meeting input to generate model output. Based on the model output, the method includes determining an action, determining a rendering of the action, and causing the digital agent to perform the action on behalf of the user according to the persona and the determined rendering.

Further aspects include monitoring the virtual meeting using a state machine, wherein the state machine implements a thought loop. Additionally, where the state machine returns to the monitoring after each iteration of the thought loop. The method further includes in response to the digital agent performing the action, detecting a proprioception of the digital agent and storing the proprioception. Additionally, where the determined rendering of the action is based at least in part on the persona.

In yet another aspect, a method of using one or more foundation models to instantiate a digital agent is provided. The method includes instantiating a digital agent with a persona associated with a user and receiving an indication to dispatch the digital agent to a virtual meeting on behalf of the user. Additionally, the method includes monitoring, by a state machine, the virtual meeting, receiving, by the state machine, meeting input, and generating a prompt comprising at least the meeting input. Based on the prompt, the method includes querying a first foundation model and receiving first output from the first foundation model. Based on the first output, the method includes determining an action and causing the digital agent to perform the action on behalf of the user according to the persona.

Additional aspects include updating the prompt with the action and querying a second foundation model based on the updated prompt. Further, where the first foundation model and the second foundation model are one of the same or different. Additionally, where the state machine implements a thought loop and where the thought loop comprises receiving state information from a previous iteration, receiving meeting input, requesting model output, receiving model output, handling model output, and sending state information to a next iteration. The method further includes determining a rendering for the action and causing the digital agent to perform the action according to the rendering.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, comprising:
instantiating a digital agent with a persona associated with a user;
receiving an indication to dispatch the digital agent to a virtual meeting on behalf of the user;
monitoring the virtual meeting;
receiving first meeting input;
processing, by a first foundation model, the first meeting input to generate first output;
based on the first output, determining a first action;
determining a first rendering for the first action; and
causing the digital agent to perform the first action on behalf of the user according to the persona and the determined first rendering.

2. The system of claim 1, wherein the persona is associated with a realistic representation of the user, a fanciful representation of the user, or any of a range of representations therebetween.

3. The system of claim 1, wherein the monitoring occurs continuously, at a regular time interval, or over a dynamic window.

4. The system of claim 1, wherein the determined first rendering of the first action is an audio rendering, a visual rendering, or an audio-visual rendering.

5. The system of claim 1, the set of operations further comprising:
receiving second meeting input;
processing, by a second foundation model, the second meeting input to generate second output;
based on the second output, determining a second action;
determining a second rendering for the second action; and
causing the digital agent to perform the second action on behalf of the user according to the persona and the determined second rendering.

6. The system of claim 5, wherein the first foundation model is one of the same or different from the second foundation model.

7. The system of claim 1, wherein the determined first rendering of the first action is based at least in part on the persona.

8. The system of claim 1, wherein determining the first action comprises one of asking the user, querying the same or different foundation model, or selecting a precached thought.

9. The system of claim 1, the set of operations further comprising:
in response to the digital agent performing the first action, detecting a proprioception of the digital agent; and
storing the proprioception.

10. A method of using one or more foundation models to instantiate a digital agent, comprising:
instantiating a digital agent with a persona associated with a user, wherein the persona is associated with at least a speech simulation and visual representation resembling the user;
receiving an indication to dispatch the digital agent to a virtual meeting on behalf of the user;
monitoring the virtual meeting;
receiving meeting input;
processing, by a foundation model, the meeting input to generate model output;
based on the model output, determining an action;
determining a rendering of the action; and
causing the digital agent to perform the action on behalf of the user according to the persona and the determined rendering.

11. The method of claim 10, further comprising:
monitoring the virtual meeting using a state machine, wherein the state machine implements a thought loop.

12. The method of claim 11, wherein the state machine returns to the monitoring after each iteration of the thought loop.

13. The method of claim 10, further comprising:
in response to the digital agent performing the action, detecting a proprioception of the digital agent; and
storing the proprioception.

14. The method of claim 10, wherein the determined rendering of the action is based at least in part on the persona.

15. A method of using one or more foundation models to instantiate a digital agent, comprising:
instantiating a digital agent with a persona associated with a user;
receiving an indication to dispatch the digital agent to a virtual meeting on behalf of the user;
monitoring, by a state machine, the virtual meeting;
receiving, by the state machine, meeting input;
generating a prompt comprising at least the meeting input;
based on the prompt, querying a first foundation model;
receiving first output from the first foundation model;
based on the first output, determining an action; and
causing the digital agent to perform the action on behalf of the user according to the persona.

16. The method of claim 15, further comprising:
updating the prompt with the action; and
querying a second foundation model based on the updated prompt.

17. The method of claim 16, wherein the first foundation model and the second foundation model are one of the same or different.

18. The method of claim 15, wherein the state machine implements a thought loop.

19. The method of claim 18, wherein the thought loop comprises receiving state information from a previous iteration, receiving meeting input, requesting model output, receiving model output, handling model output, and sending state information to a next iteration.

20. The method of claim 15, further comprising:
determining a rendering for the action; and
causing the digital agent to perform the action according to the rendering.
